(19) United States
(12) Patent Application Publication
(10) Pub. No.: US 2024/0185165 A1
(43) Pub. Date: Jun. 6, 2024

(54) AI-POWERED WORKFLOW OPTIMIZATION FOR FARM-LEVEL FOOD WASTE

(71) Applicant: Betafeld LLC, Beaverton, OR (US)

(72) Inventors: Tajudeen Iwalewa, Beaverton, OR (US); Alissar Yehya, Lille (FR); Babajide Ayinde, Richmond, TX (US); Asteroide Santana, Florianópolis (BR); Abdul-Akeem Olawoyin, College Station, TX (US); Yongxi Huang, Issaquah, WA (US)

(73) Assignee: Betafeld LLC, Beaverton, OR (US)

(21) Appl. No.: 18/437,628

(22) Filed: Feb. 9, 2024

(51) Int. Cl. G06Q 10/083; G06F 40/284; G06F 40/295; G06Q 10/04; G06T 7/00; G06V 20/68

(52) U.S. Cl. CPC G06Q 10/083; G06F 40/284; G06F 40/295; G06Q 10/04; G06T 7/001; G06V 20/68

(57) ABSTRACT

Systems and methods of the present disclosure relate to workflow optimization for farm level food waste. A method includes employing a material database design for identifying new uses for food waste. The method further includes image processing for verifying aesthetic imperfections of produce, and supply chain optimization for addressing supply chain challenges.

### BACKGROUND

More than one-third of farm produce is wasted, leading to the squandering of critical resources like agricultural land, labor, water, and energy. Typically, platforms in the farm-level food waste market operate as marketplaces, facilitating the posting, discovery, and purchase of imperfect and surplus produce. However, they lack advanced technology, relying solely on buyers' opinions and preferences for decision-making. Thus, there exists a need for techniques that improve upon and advance logistics for the farm-level food waste market.

### SUMMARY

The present disclosure is directed to workflow optimization for farm-level food waste. In some examples, a method includes receiving information from at least one publication. The information is received by a material database design. Data is extracted from the information with artificial intelligence, and the data is characterized with the artificial intelligence. The data includes potential use(s) of wasted produce, industries for the wasted produce, and processing methods of the wasted produce. A material valorization database is outputted. The material valorization database includes valorized data that includes new uses of the wasted produce, the industries for the wasted produce, and the processing methods of the wasted produce. At least one input is received from a farmer. The input includes an image of farm produce and a description of the farm produce. The image is compared to the description via artificial intelligence. The aesthetic imperfections of the farm produce are outputted when the description matches the image. The aesthetic imperfections of the farm produce, price and weight of the farm produce, and name and location of a farm that includes the farm produce, are provided to a supply chain design.

An input by the buyer and an input by a logistics provider are received with the supply chain design. Logistics for optimization are outputted from the supply chain design. The valorized data and the logistics are optimized. The farm ID, produce ID, production date, produce imperfections, optimal quantity and price, produce uses, optimal delivery date, optimal transportation cost, and optimal emissions are outputted.

### BRIEF DESCRIPTION OF THE DRAWING

FIG. 1 illustrates workflow optimization for farm-level food waste, in accordance with examples of the present disclosure.

### DETAILED DESCRIPTION

The disclosed examples will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The systems and methods, as described herein, include a platform that is based on artificial intelligence, including image processing and deep learning, as well as a powerful prescriptive analytics engine that includes mathematical optimization. The platform is a pivotal bridge between farmers and a diverse array of buyers, including food and beverage companies and biorefineries, for example.

The platform may execute operations in three parts: i) the material database design identifies, via artificial intelligence, new uses for food waste (e.g., a material valorization database); ii) the image processing verifies, via the artificial intelligence, the aesthetic imperfections of produce; and iii) the supply chain optimization addresses, via an optimization analysis (e.g., performed by a computer), supply chain challenges.

The platform not only effectively reduces farm-level food waste but also addresses the complex logistics and supply chain challenges faced by farmers and buyers. The platform introduces unique features, including a material valorization database for exploring new uses of food waste, image verification capabilities for posted produce, and an optimization system that tackles farm-level supply chain challenges while quantifying emissions reductions.

Another unique feature of the platform is scalability, allowing potential expansion to handle various waste types beyond farm-level food waste, making it a versatile solution for diverse sectors and waste categories. These distinctive capabilities position the platform as an exceptionally innovative and competitive solution in the dynamic farm-level food waste market. By optimizing the process, the platform generates additional revenue for farmers, strengthens the agricultural economy, and ensures a more efficient and sustainable food supply chain. Moreover, redirecting food waste away from landfills via the platform contribute to a circular economy, promoting environmental justice and mitigating greenhouse gas emissions. Also, by reducing food losses, the platform improves food security and fosters equitable food distribution and socio-economic development.

The platform optimizes the reduction of farm-level food waste and addresses the complex challenges faced by farmers and companies. The platform may incorporate three key techniques: an AI-based image processing, text mining to build and continuously update a material characterization database, and a supply chain optimization algorithm. Through the platform's collaborative digital environment, farmers and companies, spanning diverse sectors such as for example, beverage, food, biorefineries, pharmaceuticals, and cosmetics, actively engage after creating accounts. Farmers with imperfect produce destined for waste, photograph and upload their items, specifying the produce type and providing its condition or a description. The AI-based image processing serves a dual purpose: ensuring customer liability protection by verifying the produce against the seller's description and assigning a rating grade based on quality.

The material database design, a hidden layer constructed through text mining, identifies novel uses for surplus produce, expanding potential buyers. An optimization engine driven by data from users (e.g., farmers and companies) and the material database design, determines the optimal path for produce, thereby matching farmers with companies and maximizing economic, environmental, and social benefits within the supply chain. This user-centric and technology-driven approach ensures a comprehensive and effective solution to address farm-level food waste.

The platform reduces farm-level food waste by efficiently connecting farmers with buyers, transforming discarded imperfect produce into a source of additional revenue for struggling farmers. This reduction in food waste contributes to environmental conservation by diverting organic materials away from landfills, mitigating greenhouse gas emissions, and promoting a circular economy. The platform extends its positive impact to society by addressing issues of environmental justice, lessening food insecurity, and fostering socio-economic development, particularly in underserved communities.

The platform's innovative supply chain optimization algorithm optimizes logistics, minimizing costs related to storage, transportation, and landfilling, creating a win-win situation for both farmers and companies. The continuous updates to the material characterization database play a pivotal role in expanding potential uses for surplus and defected produce, attracting diverse industries, and accelerating innovation in the biobased materials sector. Furthermore, the platform's scalable workflow positions it for future growth and adaptability, ensuring relevance and effectiveness in addressing various waste types and industry-specific needs.

The platform aspires to revolutionize the treatment of farm-level food waste and establish a circular economy by addressing the significant challenges hindering the creation of a new market for such waste. Leveraging advanced technologies such as AI, image processing, and mathematical optimization, the platform uniquely stands out in its multifaceted approach.

AI-driven image analysis is employed to validate the accuracy of produce descriptions provided by sellers. This ensures accountability for buyers by ascertaining the variety and condition of the produce and assigns a quality rating based on its overall condition.

In some examples, the material database design may be generated by text mining at least one of published articles, patents, or reports. The material database design uncovers novel applications for surplus and flawed produce, enhancing their value and diversifying potential uses across industries such as chemicals, pharmaceuticals, biorefineries, and food production, for example. By expanding the range of potential buyers, the platform caters to various industries, from high-quality produce for chemical and pharmaceutical companies to lower-grade produce for composting and biorefineries. This diversification reduces waste destined for landfills and ensures that better-quality produce finds its way to industries with specific standards.

The platform's optimization algorithm is developed through a human-centered process, focusing on need assessment and understanding the challenges faced by farmers and industries. This algorithm addresses logistical, buyer identification, and complex decision-making challenges while minimizing financial costs and environmental impacts through a unique multi-objective function. The platform's workflow is adaptable and scalable, allowing for future expansion to handle different waste types and industries. The features discussed above emphasize the platform's innovative technology, diverse applications, human-centered optimization, and adaptability for sustained impact.

In some examples, to enhance the versatility and broaden the application of the platform, one modification involves expanding the platform to accommodate different types of organic wastes beyond farm-level food waste, maintaining the use of the existing algorithms and methodology. This expansion entails an augmentation of the image processing component, moving beyond the identification of produce imperfections to categorizing recyclables and discerning specific features based on a material category. Concurrently, the materials database can undergo an extension to incorporate a broader spectrum of waste data types, providing a more comprehensive resource for potential uses. The optimization algorithm, designed for scalability, may adapt to a wider range, drawing strength from the expanding user and materials characterization databases.

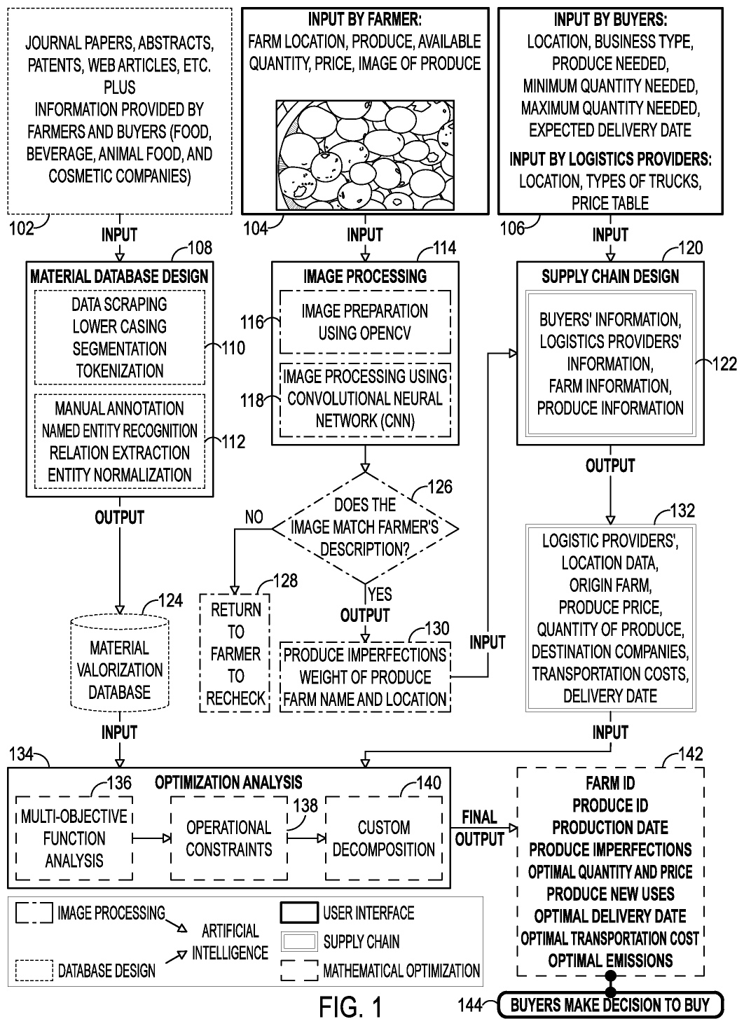

FIG. 1 illustrates workflow optimization for farm-level food waste, in accordance with examples of the present disclosure. The workflow may be implemented with the use of computer(s) and AI. Architecture elements used to integrate components of the platform may include real-time services, frontend (application, web-based), database, and application programming interface (API). Communication between different system components may be enabled using API between the backend (e.g., material valorization database, images of produce, and supply chain data) and various front-end modules, such as authentication and produce search. The back-end services may include user registration functions, data storage for users (e.g., buyer, supplier, logistics provider) and access control measures, to ensure that only authorized users have access to data.

The buyer may be able to search the platform for produce and make requests through an app/website that communicates with the backend over the internet. The supplier can add/delete produce to/from the database through an app/website that communicates with the backend over internet; and the logistics provider can add/delete resources available to the database through an app/website that communicates with the backend over the internet. The platform may employ a user interface (UI). The platform may provide features such as a navigation drawer and profile pages for users. Authorization protocols may be utilized so that users can log in with existing account details. A relational database schema may also be used to store user data and specific information about farm produce, new uses of produce, logistics resources, and buyer requests.

With reference to FIG. 1, information 102 may include information from a publication relating to agriculture, such as, for example: a journal article(s), web article(s), and/or abstract(s). Information 104 may include information provided by a farmer (e.g., a description including farm location, produce, available quantity, and/or price). Information 104 also may include an image of the described produce. Information 106 may include information provided/inputted by buyer(s) such as for example: location, business type, produce needed, minimum quantity needed, maximum quantity needed, and/or expected delivery date. Information 106 may also include input/information provided by logistics providers: location, types of trucks, and/or price table.

Information 102 may be an input for a material database design 108. In some examples, AI may extract and/or characterize data from information 102 in the material database design 108, at box 110 via: at least one of data scraping, lower casing, segmentation, or tokenization. In some examples, a text mining algorithm may be used to build and continuously update the material database design 108. Additionally, AI may extract and/or characterize data from information 102 in the material database design 108, at box 112 via: at least one of manual annotation, named entity recognition, relation extraction, or entity normalization. AI also may identify novel use(s) for surplus produce in the material database design 108, thus expanding potential buyers. The novel uses may be outputted via AI from the material database design 108 in the form of a material valorization database (described below).

Information 104 may be an input for image processing 114 that is performed by AI. Image processing 114 may include image preparation 116 via AI (e.g., OpenCV) and image processing 118 using AI (e.g., convolutional neural network (CNN)). Information 106 may be an input for a supply chain design 120 that includes information 122. In some examples, the supply chain design 120 may be implemented by a computer. Information 122 includes buyer information, logistics providers information, farm information, and/or produce information, for example.

AI creates and outputs a material valorization database 124 from the material database design 108. The material valorization database 124 includes new uses of the wasted produce, the industries for the wasted produce, and the processing methods of the wasted produce.

The data including the new uses of food waste, may be used to link wasted produce with various industries and companies. AI performs a comparison 126 between the image and the description of the image (i.e., image verification for posted produce). If the image does not match the description at box 128, the farmer is notified (e.g., electronic message via a user interface) so that the farmer may adjust/modify his input such that the image and description match. This process may continue/repeat until a successful match occurs. Upon a successful match, at box 130, produce imperfections, weight of produce, and farm name and location are outputted via AI from image processing 114. Image processing 114 may include pre-training the AI with different images of produce with various aesthetic imperfections that are specific to the produce. AI processes the image of the produce in the backend, and the output of the image processing is the aesthetic imperfections of the produce. AI may also assign a rating grade based on quality of the produce. The produce imperfections, weight of produce, and farm name and location may be received (e.g., via a computer) by the supply chain design 120. The supply chain design 120 may output (e.g., via a computer) at box 132: logistics providers, location data, origin farm, produce price, quantity of produce, destination companies, transportation costs, and/or delivery date(s).

The material valorization database 124 and the information from box 132 may be received by optimization analysis 134 (e.g., a computer receives the inputs and performs the analysis) that addresses farm-level supply chain challenges while quantifying emission reductions. Multi-objective function analysis 136, operational constraints 138, and/or custom decomposition 140. Equations (1)-(7) are used for the optimization analysis 134. The optimization problem to be solved is modeled to minimize the following objective function, ϕ, shown in Equation 1:

$$ϕ = {\sum }_{pijt} {sp}_{pit} \cdot {x}_{pijt} + {\sum }_{pit} {sc}_{pi} \cdot {y}_{pit} + {\sum }_{ijkt} {tc}_{ijk} \cdot {z}_{ijkt} + {\sum }_{ijkt} {co}_{ijk} \cdot {z}_{ijkt} \qquad ( 1 )$$

where the first term on the right-hand side is the produce cost, the second term is the storage cost, the third term is the shipping cost, and the fourth term is the CO2-eq emission cost. The decision variables are xₚᵢⱼₜ, which is the amount (lb) of produce p to be shipped from supplier i to buyer j in period t; yₚᵢₜ, which is the amount (lb) of produce p to be kept in inventory at supplier i from period t to period t+1; and zᵢⱼₖₜ, which equals 1 if truck k departs from supplier i to buyer j in period t and equals 0 otherwise. The parameter spₚᵢₜ is the selling price ($/lb) of produce p from supplier i in period t, scₚᵢ is the storage cost ($/lb) by supplier i of product p, tcᵢⱼₖ is the transit cost ($) to ship produce from supplier i to buyer j using truck k, and coᵢⱼₖ is the environmental cost indicator ($) for transporting from supplier i to buyer j using truck k.

Equations (2)-(7) are constraints that model operational requirements.

$$\begin{matrix}{ss}_{pi} + {ap}_{pit} = {y}_{pit} + {\sum }_{j} {x}_{pijt} , ∀ p , i , t = 1 & ( 2 ) \\ {y}_{pit - 1} + {ap}_{pit} = {y}_{pit} + {\sum }_{j} {x}_{pijt} , ∀ p , i , t > 1 & ( 3 ) \\ {y}_{pit} \leq {su}_{pi} , ∀ p , i , t & ( 4 ) \\ {\sum }_{p} {x}_{pijt} \leq {\sum }_{k} {tu}_{k} \cdot {z}_{ijkt} , ∀ i , j , t & ( 5 ) \\ {\sum }_{i} {x}_{pij , t - {tt}_{ij}} = {d}_{pjt} , ∀ p , j , t & ( 6 ) \\ {\sum }_{i , j , t} {z}_{ijkt} \leq 1 , ∀ k & ( 7 )\end{matrix}$$

where Eq. (2) and Eq. (3) are the flow balance of produce p at supplier i in period t, Eq. (4) is the storage capacity of produce p at supplier i in period t, Eq. (5) is the truck capacity constraint, Eq. (6) ensures that the total amount of produce shipped must meet demand dₚⱼₜ, and Eq. (7) is a constraint to avoid using the same truck for multiple shipments at period t. The parameter ssₚᵢ is the initial stock (lb) of produce p at supplier i, apₚᵢₜ is the available amount (lb) of produce p at supplier i in period t, suₚᵢ is the storage capacity (lb) of produce p by supplier i at any period, tuₖ is the capacity of truck k, dₚⱼₜ is the demand (lb) of produce p by buyer j in period t, ttᵢⱼ is the number of time periods to transport a produce from supplier i to buyer j. Inventory aging, route consolidation, landfill environmental cost indicator and transportation, and mixed shipments may be added to the formulation, which, due to the complexities involved, is solved using custom decomposition. The final output from the optimization analysis 134 is shown in box 142 which includes farm ID, produce ID, production date, produce imperfections, optimal quantity and price, produce uses, optimal delivery date, optimal transportation cost, and optimal emissions. A buyer makes a decision to buy the produce at box 144.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method comprising:
receiving information from at least one publication, wherein the information is received by a material database design;
extracting data from the information with artificial intelligence and characterizing the data with the artificial intelligence, the data including potential uses of wasted produce, industries for the wasted produce, and processing methods of the wasted produce;
outputting a material valorization database, the material valorization database including valorized data that includes new uses of the wasted produce, the industries for the wasted produce, and the processing methods of the wasted produce;
receiving at least one input from a farmer, the at least one input including an image of farm produce and a description of the farm produce;
comparing the image to the description with the artificial intelligence, and outputting aesthetic imperfections of the farm produce, wherein the description matches the image;
providing the aesthetic imperfections of the farm produce, price and weight of the farm produce, and name and location of a farm that includes the farm produce, to a supply chain design;
receiving with the supply chain design, an input by the buyer and an input by a logistics provider;
outputting logistics for optimization, wherein the logistics are outputted from the supply chain design;
optimizing the valorized data and the logistics; and
optimal quantity and price, produce uses, optimal delivery date, optimal transportation cost, and optimal emissions.

2. The method of claim 1, wherein optimizing occurs via multi-objective function analysis, operational constraints, and custom decomposition.

3. The method of claim 1, wherein the optimizing occurs by reducing operational costs,
increasing overall efficiency and decreasing environmental impact.

4. The method of claim 1, wherein the extracting and the characterizing occurs via named entity recognition (NER).

5. The method of claim 4, wherein the extracting and the characterizing also occur via
relation extraction (RE).

6. The method of claim 1, wherein the logistics include logistics providers, location data,
origin farm, produce, quantity of produce, destination companies, transportation costs, and delivery date.

7. The method of claim 1, wherein the artificial intelligence is pre-trained with various aesthetic imperfections that are specific to the farm produce.

8. The method of claim 1, wherein the at least one publication includes at least one of
a journal paper, an abstract, a patent, or a web article.

9. The method of claim 1, wherein the comparing repeats until the description matches
the image.

10. A method comprising:
receiving information from at least one publication, wherein the information is received by a material database design;
extracting data from the information with artificial intelligence, the data including potential uses of wasted produce, industries for the wasted produce, and processing methods of the wasted produce;
characterizing extracted data with the artificial intelligence and outputting a material valorization database, wherein the characterizing occurs via named entity recognition (NER) and/or relation extraction (RE), wherein the material valorization database includes valorized data that includes new uses of the wasted produce, the industries for the wasted produce, and the processing methods of the wasted produce;
receiving at least one input from a farmer, the at least one input including an image of farm produce and a description of the farm produce;
comparing the image to the description with the artificial intelligence, and outputting aesthetic imperfections of the farm produce, wherein the description matches the image, wherein the comparing repeats until the description matches the image;
providing the aesthetic imperfections of the farm produce, price and weight of the farm produce, and name and location of a farm that includes the farm produce, to a supply chain design;
receiving with the supply chain design, an input by the buyer and an input by a logistics provider;
outputting logistics for optimization, wherein the logistics are outputted from the supply chain design;
optimizing the valorized data and the logistics; and
optimal quantity and price, produce uses, optimal delivery date, optimal transportation cost, and optimal emissions.

11. The method of claim 10, wherein optimizing occurs via multi-objective function analysis, operational constraints, and custom decomposition.

12. The method of claim 10, wherein the at least one publication includes at least one of a journal paper, an abstract, a patent, or a web article.

13. The method of claim 10, wherein the artificial intelligence is pre-trained with various aesthetic imperfections that are specific to the farm produce.

14. The method of claim 10, wherein the optimizing occurs by reducing operational costs,
increasing overall efficiency and decreasing environmental impact.

15. The method of claim 10, wherein the extracting and the characterizing occur via data scraping, lower casing, segmentation, and/or tokenization.

16. The method of claim 10, wherein the extracting and the characterizing occur via manual annotation and/or entity normalization.

17. The method of claim 10, wherein the logistics include logistics providers, location data, origin farm, produce, quantity of produce, destination companies, transportation costs, and delivery date.

18. A method comprising:
receiving information from at least one publication, wherein the information is received by a material database design;
extracting data from the information with artificial intelligence and characterizing the data with the artificial intelligence, the data including potential uses of wasted produce, industries for the wasted produce, and processing methods of the wasted produce;
outputting a material valorization database, the material valorization database including valorized data that includes new uses of the wasted produce, the industries for the wasted produce, and the processing methods of the wasted produce;
receiving at least one input from a farmer, the at least one input including an image of farm produce and a description of the farm produce;
comparing the image to the description with the artificial intelligence, and outputting aesthetic imperfections of the farm produce, wherein the description matches the image, wherein the artificial intelligence is pre-trained with various aesthetic imperfections that are specific to the farm produce, wherein the comparing repeats until the description matches the image;
providing the aesthetic imperfections of the farm produce, price and weight of the farm produce, and name and location of a farm that includes the farm produce, to a supply chain design;
receiving with the supply chain design, an input by the buyer and an input by a logistics provider;
outputting logistics for optimization, wherein the logistics are outputted from the supply chain design;
optimizing the valorized data and the logistics; and
outputting farm ID, produce ID, production date, produce imperfections, optimal quantity and price, produce uses, optimal delivery date, optimal transportation cost, and optimal emissions.

19. The method of claim 18, wherein the logistics include logistics providers, location data, origin farm, produce, quantity of produce, destination companies, transportation costs, and delivery date.

20. The method of claim 18, wherein the at least one publication includes at least one of a journal paper, an abstract, a patent, or a web article.
